(19) United States
(12) Patent Application Publication
(10) Pub. No.: US 2014/0279823 A1
(43) Pub. Date: Sep. 18, 2014

(54) LIFECYCLE PRODUCT ANALYSIS

(71) Applicant: MICROSOFT CORPORATION, Redmond, WA (US)

(72) Inventors: Tao Wang, Bellevue, WA (US); Sridhar Srinivasan, Sammamish, WA (US); Piyush Agrawal, Redmond, WA (US)

(73) Assignee: Microsoft Corporation, Redmond, WA (US)

(21) Appl. No.: 13/833,250

(22) Filed: Mar. 15, 2013

(51) Int. Cl. G06F 17/30

(52) U.S. Cl. CPC G06F 17/30592
USPC 707/600

(57) ABSTRACT

Metadata is obtained regarding a data system instance. The metadata is sent to a server in a multi-tenant data center. Analysis results are received that indicate the results of an analysis performed on the metadata by a tool at the multi-tenant data center.

### BACKGROUND

Data systems are currently in wide use. Configuring such systems properly, in order to serve an organization's needs, can be quite difficult. In addition, even once a data system is deployed, during its lifecycle, it can be difficult to analyze the ongoing operation of the system, and whether upgrades might be beneficial.

In one specific example, business data systems are used by many organizations in order to perform business operations. Business data systems can include, for example, enterprise resource planning (ERP) systems, customer resource management (CRM) systems, and line-of-business (LOB) systems and other business data systems.

Business data systems can be purchased by an organization, and deployed by that organization, in order to meet the business needs of the organization. However, these types of business data systems can be relatively large and complicated. Therefore, designing and deploying them in the most efficient or effective way, can be difficult.

When an organization shops for and eventually buys and deploys a business data system, a normal lifecycle includes a number of phases. A first phase can be performed at presale or startup. In this phase, the organization is attempting to shop for a business data system and identify an appropriate business data system that will serve its needs. During the presale process, it can be difficult for a potential customer to have an idea of what equipment is needed to deploy a business data system, and what licensing may be needed. In addition, it can be difficult to know how much of a given business data system functionality will meet the needs of the organization, and how much will need to be modified or developed.

A second phase may include designing or developing the business data system, once it is purchased, in order to meet the specific needs of the organization. This can involve making modifications to a base form of the business data system. Once in the development phase, it can be difficult to know whether a developer is following the best practices of the seller of the business data system, or whether the developer's product could be improved or otherwise modified to operate more efficiently. In the past, the developer has had to provide its code to the seller for analysis, and then wait for analysis results. In addition, the analysis performed by the seller is often a highly manual process.

During a third phase, the product is actually deployed. When the business data system has moved out of the development and into the deployment phase, it can be difficult to know whether the business data system is deployed in the most efficient and highest performing way possible.

During the final phase, the product is operated at the organization. If the organization is growing or changing, or if the business data system is further developed by the seller, it may be that the organization could benefit from an upgrade. However, it can also be difficult to tell whether upgrades to the business data system will be helpful, or which upgrades might be more helpful than others.

The discussion above is merely provided for general background information and is not intended to be used as an aid in determining the scope of the claimed subject matter.

### SUMMARY

Metadata is obtained regarding a data system instance. The metadata is sent to a server in a multi-tenant data center. Analysis results are received that indicate the results of an analysis performed on the metadata by a tool at the multi-tenant data center.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIGS. 1 and 1A (collectively FIG. 1) show one embodiment of a business data system architecture.

FIG. 1 B is a flow diagram illustrating one embodiment of the overall operation of the architecture shown in FIG. 1 during a lifecycle of a business data system.

FIGS. 2A and 2B (collectively FIG. 2) show the overall operation of the architecture shown in FIG. 1 during a presale phase of the lifecycle of the business data system.

FIGS. 2C-2Q are illustrative user interface displays.

FIGS. 3A and 3B (collectively FIG. 3) are a flow diagram illustrating one embodiment of the operation of the architecture shown in FIG. 1 during the development, deployment, operation and upgrade phases of the lifecycle of the business data system.

FIGS. 3C-3T are illustrative user interface displays.

FIG. 4 shows the elements of the architecture of FIG. 1 deployed in various other architectures.

FIGS. 5-9 illustrate various mobile devices.

FIG. 10 shows a block diagram of one embodiment of a computing environment.

### DETAILED DESCRIPTION

FIG. 1 is a block diagram of one embodiment of a product lifecycle analysis architecture 100. Architecture 100 includes multi-tenant data center (e.g., a host for data for a plurality of tenants using a business data system) 102 coupled to tenants 1-N (104-106). Tenants 1-N indicate that there are a plurality (N) tenants referred to herein as tenants 104-106. However, it will be appreciated that more tenants could be hosted by multi-tenant data center 102 as well.

Tenant 104 is shown generating user interface displays 108 with user input mechanisms 110 for interaction by user 112. Tenant 106 also, of course, generates user interface displays with user input mechanisms for interaction by a user, although they are not shown. Tenants 104 and 106 illustratively access multi-tenant data center 102 over network 114.

Architecture 100 also shows that a new customer 116 has access to multi-tenant data center 102 over network 114 as well. New customer 116 is illustratively in the pre-sale phase and generates user interface displays 118 with user input mechanisms 120 for interaction by user 122.

User input mechanisms 110 and 120 can take a wide variety of different forms. For instance, they can be text boxes, buttons, dropdown menus, icons, links, or other user actuatable input mechanisms for controlling and manipulating tenant 104, new customer 116, and multi-tenant data center 102. In addition, the user input mechanisms 110 and 120 can be actuated in a wide variety of different ways. For instance, where the device displaying the user interface display is a touch sensitive screen, then the user input mechanisms can be actuated by touch gestures using the user's finger, a stylus, or another mechanism. Similarly, when tenant 104 or new customer system 116 has speech recognition components, the corresponding user input mechanisms can be actuated using voice commands. Of course, they can also be actuated using a point and click device (such as a mouse or trackball), a thumbpad, a touch pad, a keypad, hardware or soft keyboard, or another mechanism.

Multi-tenant data center 102 illustratively includes one or more processors 124, project manager component 126 and a plurality of site-wide servers (tools or other services) including business process modeler tool 128, code analysis tool 130, diagnostic engine 132, diagnostic rules 134, upgrade analysis tool 136, hotfix services 138, size estimator tool 140, licensing estimator tool 142, other servers, tools or components 144 and data viewer component 145. FIG. 1 shows that hotfix service 138 illustratively has access to a hotfix data store 146 that stores fixes that can be searched. FIG. 1 also shows that multi-tenant data center 102 illustratively includes business database servers 148, and business data stores 150 and 152. Data stores 150 and 152 are illustratively per-tenant, unshared business data stores that store business data for separate tenants. For instance, business data store 150 illustratively stores the business data for tenant 104, while business data store 152 stores business data for tenant 106. Thus, business database servers 148 illustratively maintain one or more associated databases 150 and 152.

Servers 148 can include utility servers that perform utility functions, such as reporting services, load balancing, provisioning, configuration, statistics, and other utility functions. When a new tenant is provisioned at multi-tenant data center 102, it can be assigned to one or more of the groups served by servers 128. One of servers 128 then creates a private, unshared database 150-152 for the new tenant. Associating or mapping between the tenant and the assigned group is also created and can be stored in shared data store 156, along with other configuration information.

Each tenant 104-106 illustratively corresponds to a separate organization. The organizations illustratively wish their business data to be stored in unshared databases 150-152, so that they are separate from the business data stored by other tenants.

Multi-tenant data center 102 also illustratively includes product data store 154 and shared data store 156 that stores data shared by multiple tenants. Further, FIG. 1 shows that project manager component 126 illustratively includes project creation tool 158, team selection tool 160, dashboard generator tool 162 and issue tracking component 164.

For the sake of simplicity, the present description will proceed with respect to the data hosted by multi-tenant data center 102 being for multiple on-premise instances of an enterprise resource planning (ERP) system run at tenants 104-106. It will be appreciated, however, that any type of hosted data center may be implemented using the technologies presented herein, including hosting data for other types of hosted or on-premise business applications (or hosted business data systems).

Tenant 104 is shown as including one or more database servers 172 that are coupled to a business data application store 174 that stores on-premise business data application 176 (such as an instance of an ERP system, a CRM system, an LOB system, etc.). For purposes of the present description, on-premise business application 176 will be referred to in terms of an ERP application. However, this is for the sake of example only. One or more application servers 178 provide the functionality for on-premise business application 176 and interact with database servers 172 to obtain business data, along with metadata 180 and other data 182 from business data application store 174. FIG. 1 also shows that tenant 104 illustratively includes processor 186 and user interface component 188. In addition, FIG. 1 shows that new customer system 116 can be similar to tenant 104, except that it has not yet deployed an instance of the business data system. Therefore, new customer system 116 is simply shown with a corresponding processor 190.

Processors 124, 186 and 190 are illustratively computer processors that include associated memory and timing circuitry (not separately shown). They are illustratively functional components of multi-tenant data center 102, tenant 104 and new customer system 116, respectively. They are activated by, and facilitate the functionality of, other items in multi-tenant data center 102, tenant 104 and new customer system 116, respectively.

It will be noted that, while FIG. 1 shows various blocks, components, tools, etc., these items can be divided into further blocks to divide the functionality. In addition, the functionality of two or more blocks can be combined into a single block as well. Also, while the data stores shown in FIG. 1 are shown local to multi-tenant data center 102 or tenant 104, they can be remote and accessible by data center 102 and tenant 104 as well. Similarly, instead of a single data store (where one is shown in FIG. 1) multiple different data stores can be used. In addition, where multiple data stores are shown, a single data store can be used. Where multiple data stores are shown, some can be local and others can be remote. All of these architectures are contemplated herein.

Before providing a detailed description of the operation of architecture 100, a brief description will be provided as an overview. New customer system 116 is illustratively the system of a customer who is in the pre-sale phase of acquiring a business data system. Therefore, they are attempting to identify an appropriate business data system, determine whether it will meet their organizational needs, determine what type of license they will need, as well as the sizing of various hardware or other equipment that they will need.

Tenant 104 illustratively already has an instance of the business data system. Therefore, tenant 104 can be in the development, deployment, or operational phases of the lifecycle of the business data system.

Therefore, in one embodiment, user 122 can access various tools on multi-tenant data center 102 to receive pre-sale help. For instance, use 122 can user business process modeler tool 128 to identify the various business processes that are available on the business data system that the user is reviewing. In addition, the user can use tool 128 to modify representations of those business processes to meet their own needs, and then have tool 128 provide an indication as to what needs to be done in order to make the business data system actually meet the needs of the organization or customer of system 116. In addition, user 122 can invoke sizing estimator tool 140 and licensing estimator tool 142 in order to determine the size of equipment or other systems needed for development of the business data system and the types of licenses that may be needed.

Once user 122 decides to use the business data system, user 122 can use project manager component 126 to create a new project, identify key members for the project, create issues and track issues for the project, and view a dashboard corresponding to the project. Similarly, once the new customer enters the development, deployment and operational phases (such as tenant 104), the user 122 (or 112) can use project manager component 126 to track the progress of the project. Similarly, the users can use code analysis tool 130 to obtain analysis results for the code that has already been developed. In this way, the users can identify issues with the code, even before it is deployed.

Once deployed, diagnostic engine 132 can be used to obtain diagnostic information from the particular tenant (and the environment of the business data system). Engine 132 can then run diagnostic rules 134 against the diagnostic data to provide evaluation results and recommendations to enhance the performance of the instance of the business data system for the given tenant where it is deployed.

Similarly, during the operational phase, the tenants or users may encounter problems or bugs. They can use hotfix service 138 to identify whether any problems or bugs have already had fixes developed for them. If so, the fixes can be reviewed or downloaded and incorporated in the given instance of the business data system.

In addition, tenants or users can use upgrade analysis tool 136 during the operational phase of the business data system. Tool 136 provides evaluation results which indicate whether the tenant or user would benefit from an upgrade to their particular instance of the business data system, and what the specific upgrade might be.

FIG. 1B is a flow diagram illustrating one embodiment of the overall operation of architecture 100 shown in FIG. 1 in more detail. In FIG. 1B, either a tenant or a new customer system first obtains data (or metadata) from a user about either an existing instance or a potential new instance of a business data system. This is indicated by block 200 in FIG. 1B. Of course, this can be an existing instance 202 (such as that shown in tenant 104) or a future, new instance 204, such as that input by new customer system 116. The data that is received will, of course, vary by implementation. Similarly, it will vary based upon where the instance is in the product lifecycle. If it is a future instance, then that instance is in the pre-sale phase of the product lifecycle. If it is an existing instance, then that instance could be in the development, deployment or operational phases of the product lifecycle.

In any case, the data is sent to a server or tool on the multi-tenant data center 102. This is indicated by block 206 in FIG. 1B. Some of the various tools or engines or other components are listed in FIG. 1B, and are given similar numbers to those shown in FIG. 1. Of course, it could be provided to other tools, engines or services 208 at multi-tenant data center 102 as well.

The given tool, engine or service then performs analysis on the data. Data viewer component 145 illustratively generates a view of the results of the analysis and returns them to the particular tenant 104-106 or new customer system 116, from which the original data (or metadata) came. In one embodiment, data viewer component 145 provides a view of the data through a web interface. Of course, the data can simply be provided and the user interface displayed for viewing the data can be generated by user interface component 188 on tenant 104, or a similar component on new customer system 116. In any case, receiving the display data indicative of the analysis of the uploaded data by a tool or other engine or analyzer on multi-tenant data center 102 is indicated by block 210 in FIG. 1B.

Then, a user interface display is generated and shown to a user. The user interface display displays the analysis results provided by multi-tenant data center 102. In some cases, the display can also display the raw data received by multi-tenant data center 102, upon which the analysis was performed. In any case, generating the user interface display with the analysis results is indicated by block 212 in FIG. 1B.

FIGS. 2A and 2B (collectively FIG. 2) show a flow diagram of one embodiment of the operation of various tools in multi-tenant data center 102, in more detail. FIGS. 2C-2Q are illustratively user interface displays. FIGS. 2-2Q will now be described in conjunction with one another. FIG. 2 specifically shows the operation of architecture 100 in using portions of project manager component 126, sizing estimator tool 140, licensing estimator tool 142 and business process modeler tool 128. These might be used during the pre-sale phase of the business data system. These same types of operations can be performed by an existing customer, if that customer wishes to start a new project, or purchase a new business data system. Therefore, FIGS. 2-2Q will be described with respect to tenant 104 performing various operations. However, it will be noted that the pre-sale operations could also be performed by user 122 using new customer system 116, when user 122 is going to purchase a business data system for the first time.

User 112 first provides inputs through user interface displays 108, to access project manager component 126 on multi-tenant data center 102. Project manager component 126 then generates a log-in user interface display that is provided as one of user interface displays 108, to user 112. Generating the user interface display to receive user login information is indicated by block 214 in FIG. 2.

FIG. 2C shows one embodiment of a user interface display 216. User interface display 216 illustratively includes a user name text box 218 and a password text box 220. Thus, user 112 can log into project manager component 126 using user input mechanisms 110. Similarly, if user 112 is simply shopping, the user may be able to access a link, such as link 222 to access project manger component or other items in multi-tenant data center 102 for a single use.

Project manager component 126 then illustratively provides a set of user interface displays to user 112 that allow user 112 to create a new project. This is indicated by block 224 in FIG. 2. FIG. 2D shows a user interface display 226 that allows the user to select an organization name as a customer or a partner. Using an organization name or partner is indicated by block 228 in FIG. 2.

Project creation tool 158 then illustratively generates a user interface display, such as user interface display 230 shown in FIG. 2E. User interface display 230 illustratively has a learn section 231 and a project section 232. Learn section 231 illustratively includes a set of user actuatable input mechanisms or tiles 234 that allow the user to actuate them and be navigated to a different page so that the user can learn about a given business data system, about potential sources of information, and even about an application lifecycle.

In project section 232, user 112 can illustratively select a projects user input mechanism 236 that shows existing projects for this user (although none of them will be the project that the user is going to create). In addition, project request mechanism 238 can be actuated by user 122 to review any project requests that have been made of the user. Similarly, new project input mechanism 240, when actuated by the user, navigates the user to a set of user interface displays that allow the user to create the new project. User input mechanism 242 allows the user to view various users of the system, or corresponding to the various projects, etc. In addition, user interface display 230 illustratively includes an announcement section 244 that includes various announcements for various projects in new customer system in tenant 104.

User management will first be described. When the user 112 actuates user input mechanism 242, the user can illustratively review and invite various organization users to participate in various projects. This is indicated by block 246 in FIG. 2.

FIG. 2F shows a user interface display 248 which illustratively simply lists the users of the organization corresponding to tenant 104. This listing includes the user's name, the organization, the email address of the user, the role occupied by the user, along with the date that the user's record was created. User interface display 248 also includes an add button 250, an edit button 252 and a remove button 254. The user can highlight one of the user records in list 248 and click the remove button 254 to remove it from the list. Similarly, the user can highlight a record and click the edit button 252 to edit the record, and the user can simply click the add button 250 to add a new user record.

User 112 can then access team selection tool 160 to select a team for a given project. In doing so, tool 160 illustratively displays a user interface display, such as display 256 shown in FIG. 2G, that allows user 112 to invite another organizational user to participate in a project. User interface display 256 provides text boxes or other user input mechanisms for user 112 to input the other person's first name, middle name, last name, email address, and to assign them a security role. Text boxes 258 allow the user to type in them, while box 260 allows the user to select from a dropdown menu. By actuating send button 262, team selection tool 160 sends the invitation to the identified user.

Project creation tool 150 also generates a project creation user interface display such as user interface display 166 shown in FIG. 2H. This includes user input mechanisms that allow user 112 to input project details for the new project. This is indicated by block 268 in FIG. 2. Some of the user input mechanisms include text box 270 that allow the user to name the project, box 272 that allows the user to describe it, the project type which can be selected from dropdown menu 274 (such as presales, development, deployment, operation, etc.). User input mechanism 276 allows the user to select a specific product from a dropdown menu, and user input mechanism 278 allows the user to select a version of the product selected with mechanism 276. In addition, user interface display 266 provides a plurality of actuators shown generally at 280 that allow the user to assign a particular industry type to this project. User interface display 266 also includes input mechanisms 282, 284, 286 and 288 that allow the user to input the customer organization name, primary contact, partner organization name and partner primary contact. The user can then actuate the create button 290 to have the new project created and saved.

The user can also provide inputs to generate a project timeline to indicate when certain phases of the project should be completed. This is indicated by block 292 in FIG. 2.

In addition, the user can generate an issue list and assign an owner to each of the issues generated, and this is indicated by block 294. FIGS. 2I-2K show user interface displays 296, 298 and 300, respectively that allow a user to do this. The user 112 illustratively accesses issue tracking component 164 in project manager component 126 to manage issues. User interface display 296 illustratively shows a list of issues that need to be addressed. Buttons 302 can be actuated by the user to add issues, edit issues, remove issues, or view additional information for a given issues. User interface display 296 shows that the issue list identifies the issue by identification number, title, type, a priority level, a severity level, and it also indicates who the issues is opened by and assigned to, the status of the issue, and when the issue entry was last modified. Of course, these are exemplary only.

User interface display 298 shows that when the user actuates the view button a pop-up menu 304 is displayed which allows the user to select which type of issue to view. In the embodiment shown in FIG. 3J, the user can view a bug, a work item, or a risk.

FIG. 2K shows user interface display 300 which can be generated by issue tracking component 164 to allow the user to add an issue. The user can input the title with mechanism 306, and the user can assign the type, priority level, severity level, owner and status of the issue using user input mechanisms 308, 310, 312, 314 and 316, respectively. The user can also identify himself or herself as the person that created the issue by using mechanism 318. In addition, the user can describe the issue in textbox 320. When the user is finished, the user can save the new issue by actuating button 322.

In addition, returning again to FIG. 2, the user can provide other inputs 324 to create a project or specify an issue for a project, etc. Once the user has provided those inputs, the user can actuate a user input mechanism to save the new project as indicated by block 326.

Also, during the presale phase of a product, the user can access sizing estimator tool 140 in multi-tenant data center 102 to obtain an estimate as to the sizing of the hardware, software, databases, systems, etc. required by the user. In order to do that, user 112 first provides an input indicating to sizing estimator tool 140 that user 112 wishes to obtain a size estimate. In response, sizing estimator tool 140 provides a user interface display, such as user interface display 324 shown in FIG. 2L. User interface display 324 provides a plurality of sections of information that can be collected from the user 112 in order to provide the sizing estimate. In the embodiment shown in FIG. 2L, user interface display, 324 includes a general information section 326, a user information section 328 and a transaction information section 330, as well as an additional information section 332. These sections gather information about the organization's use of the business data system. When the user has completed inputting the information, the user can actuate submit button 334 to upload the information for processing by sizing estimator tool 140. Displaying the sizing user interface to receiving sizing user inputs is indicated by blocks 336 and 338 in FIG. 2. Having the sizing estimator tool 142 estimate the size of the various components and systems needed is indicated by block 340. When the estimate is complete, sizing estimator tool 140 illustratively provides the information to tenant 104 for display to user 112. Displaying the sizing recommendations is indicated by block 342 in FIG. 2.

User 112 can also access multi-tenant data center 102 to obtain an estimate of the licensing that will be used for a given business data system. The user illustratively provides user inputs to access licensing estimator tool 142. In response, licensing estimator tool 142 illustratively generates a user interface display, such as user interface display 350 shown in FIG. 2M. User interface display 350 allows the user to input a variety of different information that enables licensing estimator tool 142 to estimate the types and numbers of licenses that may be needed. For instance, the user can input the number of employees 352, the number of vendor users 354, whether it is a new implementation at 356, and select a variety of different departments at 358 that are used by the organization to which the user belongs. User interface display 350 also includes identifying information 360 that identifies the organization and the project name, as well as the project description and industry corresponding to the license estimation. This information generally indicates how the organization will use the business data system. The user can then actuate the create button 362 to provide the information to licensing estimator tool 142. Generating the user interface display to receive the user inputs is indicated by blocks 364 and 366 in FIG. 2, and having licensing estimator tool 142 perform the estimation is indicated by block 368.

Once the estimation is complete, licensing estimator tool 142 illustratively downloads a licensing estimation that can be displayed to user 112. Displaying the licensing estimations or recommendations is indicated by block 370 in FIG. 2. By way of example, the recommendation display may indicate that the user needs an enterprise license, a set of individual licenses, or other types and number of licenses.

User 112 can also access business process modeler tool 128 in multi-tenant data center 102. This allows the user to view process model maps that are diagrams of process models that already exist in a base business data system (such as in a base ERP or CRM system) as sold by the seller. It also allows the user to make changes to those maps to identify changes to be made to the base system, in order for the process to accurately meet the needs of the organization to which the user belongs. Tool 128 can then generate a work item list or a fit gap list that indicates the items of work that need to be developed or modified relative to the base business data system in order to have it meet the desired needs of the organization.

In order to do this, user 112 illustratively provides user inputs to access business process modeler tool 128. In response, tool 128 illustratively generates a user interface display, such as user interface display 370 shown in FIG. 2N. Display 370 allows the user to select solution maps that have already been generated at 372, or solution maps that have been created by this user at 374. In addition, the user can select existing maps for an industry at 376. When the user provides a selection, modeler tool 128 illustratively generates a tree view, such as that shown at user interface display 378 in FIG. 2O. The display 378 illustratively breaks the processes down into core business processes 380 and support processes 382. By selecting one of the nodes in the hierarchical display, the user can expand the tree view to a display such as display 384 shown in FIG. 2P. This exposes a set of leaf nodes, generally shown at 386, which can be selected by the user.

When the user selects a leaf node, a business process model is illustratively displayed in flow diagram form. The user can then drag and drop shapes in the flow diagram to modify the flow diagram, or the user can add shapes and connectors in the flow diagram or delete shapes and connectors from the flow diagram, in order to modify the diagram of the desired business process. Based upon the modifications, tool 128 generates a list of work items or a fit gap list or other documentation indicating what needs to be done to the base process in order to meet the needs of the organization to which the user belongs.

In addition, if the user desires to create his or her own business process, tool 128 illustratively displays a user interface display such as display 388 shown in FIG. 2Q. This provides a canvas 390 as well as a set of activities identified by shapes 392. The user can drag and drop the shapes onto canvas 390, assign connectors to the shapes and assign security roles by placing the shapes adjacent a role indicator 394 that the user can also drag and drop onto canvas 390.

Generating the user interface display to receive user inputs to view and modify process diagrams is indicated by blocks 396 and 398 in the flow diagram of FIG. 2. Having tool 128 revise the metadata corresponding to the business process model, based on the user modifications is indicated by block 400, and generating documentation indicative of the modifications is indicated by block 402. Again, this documentation can be in the form of a fit gap list 404, step-by-step instructions for performing the process at 406, or a list of work items or other documentation 408.

FIGS. 3A and 3B (collectively referred to as FIG. 3) show a flow diagram illustrating the operation of architecture 100 in displaying a dashboard for a selected project, performing code analysis, processing hotfix requests, processing diagnostic requests, and performing upgrade analysis, in more detail. It will be noted that, in one embodiment, displaying the dashboard for a selected process can be performed at any point in the lifecycle of a business product. It can be helpful to a developer who is working on the project and developing or modifying the base business data system for deployment at an organization. Performing code analysis is illustratively done during the development phase of the business data system. Processing hotfix and diagnostics requests, as well as performing upgrade analysis, are all illustratively performed during the operational phase of the business data system.

In order to generate a dashboard display for a selected product, user 112 first illustratively accesses project manager component 126, and specifically dashboard generator tool 162 to indicate that user 112 desires to see the dashboard view for a product. In response, tool 162 illustratively generates a user interface display that allows user 112 to select a project. This is indicated by block 410 in FIG. 3. FIG. 3C shows one illustrative user interface display 412 for doing this. It can be seen that user interface display 412 displays a project list 414 that shows various projects for the organization to which the user belongs. The user can simply click on one of the projects in the list to display the dashboard.

In response, dashboard generator tool 162 illustratively generates a dashboard display, such as user interface display 416 shown in FIG. 3D. User interface display 416 is illustratively divided into a general section 418 that displays general information and a phases section 420 that provides information about the various phases of the business data system. The general information section 418 illustratively includes a project section 421 that, when actuated, navigates the user to a plan for the selected project, a summary section 422 that summarizes the project, a user section 424 that allows the user to view other users on the project, a roles section 426 that allows the user to view and manage roles, and it can also include other sections 428 as well.

The phases section illustratively allows the user to click on one of the displayed buttons or tiles to view information relevant to a given phase of the product, such as the analysis phase and the design phase (which can precede the development phase or be part of it), the development phase, the deployment phase, or the operational phase. The phases section also illustratively includes a status indicator, such as when a given phase was completed.

Dashboard 416 also illustratively includes an issue service actuator 428 and an issue tracking actuator 430. Issues service actuator 428 allows the user to manage, view and add or delete issues for the project, and the issue tracking actuator 430 illustratively allows the user to accurately track the progress in solving various issues. Deliverables actuator 432 allows the user to get an update as to the status of the various deliverables. Dashboard 416 also illustratively includes a tools section 434. This allows the user to actuate a user input mechanism (such as a link or tile) in order to invoke one of the tools on multi-tenant data center 102. Of course, there could be other actuators or sections on dashboard 416 as well, and this is indicated by block 436 in FIG. 3.

FIG. 3E shows an alternate embodiment of a dashboard at user interface display 438. It can be seen in FIG. 3E that a number of tools and analysis engines are displayed across the top of the dashboard for easy access by the user.

FIG. 3F shows one embodiment of a summary user interface display 440. The summary user interface display 440 is illustratively displayed when the user actuates summary tile 422 (shown in FIG. 3D). User interface display 440 illustratively includes a project information section 442, a work items section 444, and a code review section 446. Project information section 442 illustratively displays information identifying and describing the project. The user can select a user input mechanism 448 to review a list of users that are assigned to the project.

Work item section 444 illustratively displays a breakdown of the various work items (such as bugs) and the number of them that are open, in progress, and closed. Similarly, a temporal display can be used to show the number of items that have been opened, are in progress, or have been closed within the last seven days (or any other desired period of time). Code review section 446 illustratively displays the results of any code review that have been performed on the code, to date.

FIG. 3G illustratively shows a user interface display 450 that can be generated when the user actuates the project plan tile 421 in FIG. 3D. Interface 450 can include a checklist section 452 that shows check list items that need to be performed, a tools and service section 454 and a documents and template section 456.

User interface displays 458, 460 and 462 (shown in FIGS. 3H, 3I and 3J) can be generated by project manager component 126, when the user actuates the team actuator 424, or the user list actuator 448 shown in FIGS. 3E and 3F, respectively. User interface display 458 shown in FIG. 3H generates a list 464 of users that have been assigned to the project. The list 464 identifies the users by name, organization, title, role, who they were added by, what organization they were added by, when the user record was created and the status (whether the user has accepted or declined the invitation, or whether the invitation is still pending).

User 112 can invite another user to be added to the project also. In response, team selection tool 160 illustratively displays user interface display 460 shown in FIG. 3I. This allows the user 112 to either add the user from an organization by actuating button 466 or to add an external user by actuating button 468. When the user adds a user from the present organization (for example, the tenant to which the user 112 belongs) user 112 simply inputs the invited user's last name in box 470 and title in box 472, and selects their project role by using input mechanism 474. The user can then simply invite the user by actuating button 476. When the user 112 wishes to invite another from an external organization, the process is similar, except that some additional information is requested, such as the company name at block 478, the first and middle names at blocks 480 and 482, and the email address at block 484. This is shown at user interface display 462 in FIG. 3J

Referring again to the dashboard of FIG. 3E for a given project, when the user actuates role management tile 426, project manager component 128 illustratively generates a set of user interface displays, with user input mechanisms, that allow user 112 to manage the roles that have been assigned to a given project. In one embodiment, user interface display 486 shown in FIG. 3K is generated. User interface display 486 illustratively shows a list of roles 488 that have been created for the given project. They can be listed by role name, description, role type, and the date they were created and who they were created by. When the user 112 wishes to create a new role, user 112 can simply actuate the “add” button 490. In response, user interface display 492, such as that shown in FIG. 3L, can be generated. This allows user 112 to name a new role at 494, describe the role at 496, and assign permissions to the newly created role by checking various boxes at 498. The user can them simply save the new role by actuating button 500, and the new role will be saved and displayed in the list 488 for this project.

The user can perform all these and other functions from the displayed dashboard. Displaying the dashboard and performing these functions is indicated by block 502 in the flow diagram of FIG. 3.

During the development phase of the business data system, user 112 may author or modify code. User 112 then may desire to have the code analyzed to determine whether it meets best practices, or analyzed for other reasons. Thus, user 112 may wish to invoke code analysis tool 130 in multi-tenant data center 102. User 112 can access tool 130 to upload code for analysis. In response, tool 130 can generate a user interface display, such as display 504 shown in FIG. 3M. This allows the user to select a name of the code at 506, and a type of analysis requested at block 508. Display 504 also shows the status of the analysis at 510, and can include a name when the record was created at 512 and the date it was created on at 514.

In addition, tool 130 can generate a user interface display, such as display 516 shown in FIG. 3N. This allows user 112 to name the code, describe it at 518 and 520, respectively, and to identify the version of product, the build number, and the analysis category by selecting from dropdown menus 522, 524 and 526. When the user actuates create button 528, a packet of code is created that can be uploaded to tool 130 for analysis. Requesting analysis on code, describing the code, and specifying the code to upload is indicated by blocks 530, 532 and 534 in the flow diagram of FIG. 3A.

A user interface display, such as display 536 shown in FIG. 3O, is then displayed to allow user 112 to actually upload the code. User 112 can select a file type at 538, and file location at 540 and then simply click the upload button 542 to upload the code to multi-tenant data center 102, where it can be scheduled for analysis by code analysis tool 130. Code analysis tool 130 then performs the requested analysis on the code, and this is indicated by block 544 in the flow diagram of FIG. 3. The analysis results are then provided by tool 130 for display to the user. Receiving and displaying the results of analysis at tenant 104 are indicated by block 546 in the flow diagram of FIG. 3.

FIG. 3P shows one illustrative user interface display 548 that displays analysis results. FIG. 3P illustratively shows the status of the various analyses that are to be performed at 550, and includes a plurality of links to different types of reports at 552. If the user actuates one of the links, the user will be navigated to the report. Display 548 also illustratively includes a service summary section 554 that summarizes a description of the code that was analyzed and the type of analysis performed.

During either the deployment or the operational phase of the business data system, it may be that user 112 encounters various problems. However, these problems may have been already encountered by other users of the business data system, and so fixes may have already been generated for those problems. Therefore, user 112 may desire to access hotfix service 138 in order to search for and download existing fixes to problems that user 112 is encountering.

In one embodiment, in order to do this, hotfix service 138 generates a set of user interface displays that allow the user to search for already-existing fixes. FIG. 3Q shows one illustrative user interface display 556 that includes issues search box 558 that allows a user to enter search terms to look for a fix. FIG. 3R illustrates a user interface display 560 that shows that the user has input a word “read” into search box 558. In response, hotfix service 138 illustratively searches hotfix data store 148 for relevant fixes corresponding to the term to be searched. Some links to relevant fixes are provided at 562 and 564 in FIG. 3R. Generating the user interface display to receive a search input is indicated by blocks 566 and 568 in the flow diagram of FIG. 3, and searching for results and displaying the results to the user are indicated by blocks 570 and 572 in the flow diagram of FIG. 3.

When the user actuates one of the links 562 and 564, additional information can be displayed. FIG. 38 shows one illustrative user interface display 574 that is generated when the user actuates link 562 in FIG. 3R. It can be seen that the additional information describes the problem, the cause of the problem, and the description of the change that needs to be made to remedy the problem. In addition, the user is provided with a download hotfix button 576 that allows the user to download the fix and a view changes button 578 that allows the user to view changes associated with the fix. Displaying the additional information about the selected result is indicated by block 580 in FIG. 3.

If the user wishes to simply download the fix and actuates button 576, the fix is automatically downloaded, and this is indicated by blocks 583 and 584. Of course, if the user wishes to view the changes corresponding to the fix, this can be done by actuating button 578. FIG. 3T shows one illustrative user interface display 586 that shows a display of changes that are viewed when the user actuates button 578. In the embodiment shown in FIG. 3T, the changes indicate the properties and subnodes that are affected.

When the business data system is eventually deployed and operating, it may not be deployed in the most efficient and high performing, way. Therefore, user 112 may wish to have the deployment diagnosed to identify possible performance improvements that can be made. In that case, the user provides a request to diagnostic engine 132. Diagnostic engine 132 discovers the environment corresponding to an instance of the business data system and collects diagnostic data from that environment. The diagnostic data can include a wide variety of different kinds of data. The diagnostic data is then uploaded to diagnostic engine 132. Receiving the diagnostic request, discovering the environment of the business data system instance and collecting and uploading the diagnostic data is indicated by blocks 588, 590, 592 and 594, respectively.

Diagnostic engine 132 then accesses diagnostic rules 134 and evaluates the diagnostic data for the environment of the instance of the business data system where the diagnostic data came from, against the diagnostic rules 134. Engine 132 then illustratively provides information that can be displayed to user 112, including the raw diagnostic data, the evaluation results, and any recommendations that are generated based on the diagnostic results. Performing the diagnostic evaluation and receiving and displaying the diagnostic data, evaluation results and recommendations at tenant 104 are indicated by blocks 596 and 598, respectively.

At any time during the operation of the business data system on tenant 104, user 112, may desire to have an upgrade analysis performed. That is, it may be that the user wishes to determine whether there are any upgrades to the business data system that may be helpful. Also, of course, an upgrade analysis can be scheduled to occur on a regular basis, or on a intermittent basis, or when some other trigger happens, such as when the number of users of the business data system exceed a given threshold, etc. In any case, determining whether it is time to perform an upgrade analysis, and uploading data about the instance of the business data system to perform an upgrade analysis are indicated by blocks 600 and 602 in FIG. 3B.

Upgrade analysis tool 136 then performs an upgrade analysis to determine whether there are any upgrades available, that may be helpful, for the instance of the business data system being run on tenant 104. Performing the analysis is indicated by block 604. Upgrade analysis tool 136 then generates display information that can be used to display the results of the upgrade analysis (such as whether upgrades are available, what those upgrades are, how much they cost, what is required to deploy them, what types of different licensing may be needed, etc.), This is indicated by block 606.

It can thus be seen that multi-tenant data center 102 can receive from a tenant or a new customer, information about a business data system in any phase of the lifecycle of the business data system and perform analysis using various engines, tools, systems, servers, etc. Multi-tenant data center 102 can then generate information that can be displayed to the user, that is indicative of the analysis performed on the data that was received. This can be used in a wide variety of different ways, to perform a wide variety of different functions.

FIG. 4 is a block diagram of architecture 100, shown in FIG. 1, except that it's elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 4, some items are similar to those shown in FIG. 1 and they are similarly numbered. FIG. 4 specifically shows that multi-tenant data center 102 is located in cloud 502 (which can be public, private, or a combination where portions are public while others are private). Therefore, user 112 uses a user device 504 that includes tenant 104 to access those systems through cloud 502.

FIG. 4 also depicts another embodiment of a cloud architecture. FIG. 4 shows that it is also contemplated that some elements of data center 102 are disposed in cloud 502 while others are not. By way of example, data stores 150, 154 can be disposed outside of cloud 502, and accessed through cloud 502. In another embodiment, code analysis tool 130 and is also outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

FIG. 5 is a simplified block diagram of one illustrative embodiment of a handheld or mobile computing device that can be used as a user's or client's hand held device 16, in which the present system (or parts of it) can be deployed. FIGS. 9-12 are examples of handheld or mobile devices.

FIG. 8 provides a general block diagram of the components of a client device 16 that can run components of data center 102 or tenants 104-106 or system 116 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like on-premise business application 176) are received on a removable Secure Digital (SD) card that is connected to a SD card interface 15. SD card interface 15 and communication links 13 communicate with a processor 17 (which can also embody processors 124, 186 or 190 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Application 154 or the items in data store 156, for example, can reside in memory 21. Similarly, device 16 can have a client business system 24 which can run various business applications or embody parts or all of tenant 104. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 6 shows one embodiment in which device 16 is a tablet computer 600. In FIG. 6, computer 600 is shown with user interface display 230 (From FIG. 2E) displayed on the display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

FIGS. 7 and 8 provide additional examples of devices 16 that can be used, although others can be used as well. In FIG. 7, a feature phone, smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 8 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

FIG. 9 is similar to FIG. 7 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

FIG. 10 is one embodiment of a computing environment in which architecture 100, or parts of it, (for example) can be deployed. With reference to FIG. 10, an exemplary system for implementing some embodiments includes a general-purpose computing device in the form of a computer 810. Components of computer 810 may include, but are not limited to, a processing unit 820 (which can comprise processor 124, 186 or 190), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during startup, is typically stored in ROM 831. RAM 832 typically contains data and/or program modules that are immediately accessible to and/or presently being operated on by processing unit 820. By way of example, and not limitation, FIG. 10 illustrates operating system 834, application programs 835, other program modules 836, and program data 837.

The computer 810 may also include other removable/non-removable volatile/nonvolatile computer storage media. By way of example only, FIG. 10 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 10, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 10 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method, comprising:
obtaining metadata associated with a data system instance;
sending the metadata associated with the data system instance to a server in a multi-tenant data center that hosts data for multiple different tenants, each tenant corresponding to a different organization; and
receiving display data indicative of analysis of the metadata associated with the data system instance, performed by a tool.

2. The computer-implemented method of claim 1 wherein the data system instance comprises a business data system instance, and further comprising:
generating a user interface display displaying the display data.

3. The computer-implemented method of claim 1 wherein obtaining metadata comprises:
displaying a diagram of a business process model from the business data system instance; and
receiving user changes to the diagram, the metadata including metadata indicative of the user changes to the diagram.

4. The computer-implemented method of claim 2 wherein obtaining metadata comprises:
automatically discovering an environment of the business data system instance; and
obtaining the metadata as diagnostic data from the environment.

5. The computer-implemented method of claim 4 wherein receiving display data comprises:
receiving evaluation results and recommendations display data based on a diagnostic evaluation of the diagnostic data from a diagnostic tool.

6. The computer-implemented method of claim 2 wherein the business data system is not yet deployed and wherein obtaining metadata comprises:
receiving a user sizing request; and
generating a user sizing display with a user input mechanism receiving user sizing inputs indicative of an estimated use of the business data system instance once it is deployed.

7. The computer-implemented method of claim 6 wherein receiving display data comprises:
receiving sizing recommendation display data indicative of recommended size specifications for equipment used to run the business data system instance based on an analysis of the user sizing inputs by a sizing estimator tool.

8. The computer-implemented method of claim 2 wherein the business data system instance is not yet deployed and wherein obtaining metadata comprises:
receiving a user licensing estimate request; and
generating a user licensing estimate display with a user input mechanism that receives user licensing inputs indicative of an estimated use of the business data system instance once it is deployed.

9. The computer-implemented method of claim 8 wherein receiving display data comprises:
receiving licensing estimation display data indicative of estimated licensing for deployment of the business data system instance based on an analysis of the user licensing inputs by a licensing estimator tool.

10. The computer-implemented method of claim 2 wherein the business data system instance is under development and represented by a set of code, and wherein sending the metadata comprises:
sending the set of code and a code analysis request to the multi-tenant data center to request analysis of the set of code by a code analysis tool at the multi-tenant data center.

11. The computer-implemented method of claim 10 wherein receiving display data comprises:
receiving code analysis result display data indicative of analysis results based on an analysis of the set of code by the code analysis tool.

12. The computer-implemented method of claim 2 wherein the business data system instance is operational and wherein obtaining the metadata comprises:
receiving a search user input indicative of a problem encountered in the business data system instance.

13. The computer-implemented method of claim 12 wherein receiving display data, comprises:
receiving fix display data indicative of problem fixes corresponding to the search user input, the fix display data providing a user input mechanism to receive a user download input to download a problem fix for implementation in the business data system instance.

14. The computer-implemented method of claim 2 wherein the business data system instance is operational and wherein obtaining the metadata comprises:
obtaining upgrade data that provides a basis for an upgrade analysis of the business data system instance.

15. The computer-implemented method of claim 14 wherein receiving display data, comprises:
receiving upgrade display data indicative of upgrade recommendations for the business data system instance based on an upgrade analysis of the upgrade data by an upgrade analysis tool at the multi-tenant data center.

16. A multi-tenant data center, comprising:
a plurality of databases, each hosting data for a different tenant, each tenant corresponding to a different organization;
a plurality of tools, each tool receiving uploaded data indicative of an on-premise data system and performing an analysis of the uploaded data to generate results display data indicative of results of the analysis of the uploaded data and providing the results display data for display at a tenant from which the uploaded data was received; and
a computer processor being a functional component of the multi-tenant data center and activated by the databases and the tools to facilitate hosting data and analysis of the uploaded data.

17. The multi-tenant data center of claim 16 wherein the on-premise data system comprises an on-premise business data system and wherein the plurality of tools comprise a pre-sale tool that performs pre-sale analysis on the uploaded data prior to a sale of the on-premise business data system, a development tool that performs development analysis on the uploaded data during development of the on-premise business data system, a deployment tool that performs deployment analysis on the uploaded data during deployment of the on-premise business data system and an operational tool that performs operational analysis on the uploaded data during operation of the on-premise business data system.

18. A computer readable storage medium that stores computer readable instructions which, when executed by a computer, cause the computer to perform steps comprising:
obtaining metadata associated with a data system instance;
sending the metadata associated with the data system instance to a server in a multi-tenant data center that hosts data for multiple different tenants, each tenant corresponding to a different organization; and
receiving display data indicative of analysis of the metadata associated with the data system instance, performed by a tool.

19. The computer-readable medium of claim 18 wherein the data system instance comprises an on-premise business data system instance and wherein receiving display data comprises:
receiving pre-sale analysis display data indicative of analysis performed on pre-sale data obtained prior to sale of the on-premise business data system.

20. The computer-readable medium of claim 18 wherein the data system instance comprises an on-premise business data system instance and wherein receiving display data comprises:
receiving development analysis display data, deployment analysis display data and operational analysis display data indicative of analysis performed on development data obtained during development of the on-premise business data system, on deployment data obtained during deployment of the on-premise business data system, and on operational data obtained during operation of the on-premise business data system, respectively.
